(19) United States
(12) Patent Application Publication
(10) Pub. No.: US 2016/0167244 A1
(43) Pub. Date: Jun. 16, 2016

(54) DEVICE FOR CUTTING MATERIAL SHEETS

(71) Applicant: Kolbus GmbH & Co. KG, Rahden (DE)

(72) Inventors: Ralf Peters, Stemwede (DE); Thomas Rohlfing, Rahden (DE)

(21) Appl. No.: 14/949,279

(22) Filed: Nov. 23, 2015

(30) Foreign Application Priority Data
Dec. 15, 2014 (DE) 10 2014 018 570.2

(51) Int. Cl. B26D 1/04; B26D 5/02

(52) U.S. Cl. CPC B26D 1/045; B26D 5/02

(57) ABSTRACT

A device for cutting plane material sheets (1) to a sectionally concave contour by separating several discontiguous sections (2, 3), with at least two cutting units (4) that respectively feature a knife (6, 8) and a cutting bar (7, 9) and can be positioned relative to one another by adjusting devices (11, 12, 13, 14) such that format adjustments and corrections can be realized without tool change.

### BACKGROUND

The present invention pertains to a device for cutting plane material sheets.

Known devices for cutting material sheets to a sectionally concave contour of the type used, e.g., on folding box blanks completely produce the desired contour in a single cutting process. For this purpose, the devices comprise a table, on which the material to be cut lies in an outstretched fashion, and a cutting tool that is arranged above the table, wherein the cutting tool is lowered onto the table and thereby separates the material sheet in a vertical guillotine cutting process. The tool consists of a contouring knife that is mounted on a base plate and respectively manufactured individually in accordance with the desired cutting contour.

In order to keep the manufacture of the tool simple, the contouring knife is bent of spring band steel and driven into a wood plate or cast into a plastic bed in order to stabilize its shape, wherein the knife reproduces the entire outer contour to be produced. The material sheet to be cut has an oversize such that the entire contour can be cut in a single process. This results in a great length of the cut, namely also on small formats, and in connection with the guillotine cut leads to high cutting forces and impact loads on the knives such that the tool has a low dimensional stability. In order to maintain this dimensional stability over a prolonged operating period, publication DE1134880B1 proposes to provide supporting inserts, which engage into U-shaped recesses of the knives, in the plastic bed, wherein these supporting inserts distribute the occurring loads over a greater area and reduce load peaks due to purposefully placed elasticities.

Since the tool respectively reproduces the complete contour to be produced, every time the contour is to be changed a new tool has to be created. Corrections of the produced geometry, as well as the manufacture of identical simple blanks that merely differ with respect to their dimensions, consequently are particularly elaborate.

### SUMMARY

The invention therefore is based on the objective of developing a device for cutting plane material sheets to a sectionally concave contour, in which the described disadvantages are eliminated.

According to the present disclosure, a device of this type comprises a geometric space, namely the so-called cutting cell, in which the horizontally outstretched and previously fed and aligned material is cut. The tools formed by knives and cutting bars assigned thereto are arranged within the cutting cell. Prior to the cutting process, the knives initially are sufficiently spaced apart from the assigned cutting bars for placing the material to be cut onto the cutting bars such that it lies in between these cutting bars on the one hand and the knives on the other hand. Subsequently, the knives move in the form of a straight guillotine cut and therefore linearly orthogonal toward the cutting bars such that they separate the material to be cut. In this way, all sections can be cut simultaneously during one work cycle. The cut blanks are then transported out of the cutting cell.

At least one knife and the associated cutting bars are combined into a cutting unit, wherein the inventive device comprises at least two such cutting units. These cutting units are arranged relative to one another in such a way that they separate several discontiguous areas from the material to be cut. The arrangement of these cutting units relative to one another is variable. For this purpose, at least one of the cutting units is connected to a first adjusting device that causes a linear displacement of the cutting unit parallel to the aligned material sheets in the cutting cell. In this way, the device makes it possible to easily change the geometry produced by the cutting process. Particularly corrections of deviations are thereby significantly simplified because the knives do not have to be exchanged and a tool change is therefore also eliminated. It is furthermore possible to carry out corrections during the ongoing operation of the device such that the production output is on the one hand increased and very precise blanks can on the other hand be produced without capacity restraints.

The device preferably comprises at least one second adjusting device that acts upon one of the cutting units, wherein this second adjusting device acts parallel to the material sheet and perpendicular to the first adjusting device such that the arrangement of the cutting units relative to one another can be adjusted independently along two orthogonal coordinate axes by means of the first and the second adjusting devices and the advantages of the invention are thereby expanded from the axis to the plane.

It is particularly advantageous if the device comprises at least one third adjusting device that varies the alignment of at least one cutting bar relative to the knife assigned thereto. In this way, the adjustment can be easily realized such that the knife comes in contact with a different area of the same cutting bar without changing the cutting contour, particularly also during the ongoing operation of the device. As the quality of the cut deteriorates due to incipient wear of the cutting bar, the contact area of the knife therefore can be shifted to a virtually new area of the same cutting bar during the operation of the device. In this way, the service life of the cutting bar can be multiplied without deteriorating the quality of the cut such that downtimes due to wear-related exchanges of the cutting bars are eliminated and the capacity of the device is increased accordingly.

In a first embodiment, the third adjusting device acts upon the cutting bar while the first or second adjusting device acting in the same direction acts upon the knife of the same cutting unit, but not upon the cutting bar. In order to ensure an identical format adjustment or correction of the knife and the associated cutting bar, the third and the first or second adjusting device are motively connected to one another, wherein this connection can be separated in order to purposefully adjust the cutting bar relative to the knife.

In an alternative embodiment, the third adjusting device is arranged between the cutting bar and the first or second adjusting device acting in the same direction in the sense of a series connection.

In order to ensure a fast and simple exchange of the cutting bars, their mounting is realized by means of clamping arrangements in a preferred embodiment of the device. It is furthermore preferred that the cutting bars have a square cross section such that four of their surfaces can be successively used for the cutting process before they have to be exchanged, wherein the consumption of wear-prone cutting bars can thereby be further reduced.

It is advantageous if the material used for the cutting bars is more yielding than the material used for the knife. Due to sharpening of the blade, the manufacture of the knives is more elaborate and therefore more expensive than that of the cutting bars, which may simply be cut to length from bar stock, such that lower operating costs can be achieved by realizing the cutting bars as the faster wearing contact partner.

In another embodiment, at least one of the knives has an angled, open contour, wherein the angle may be acute, perpendicular or obtuse such that various contours and formats of the material blanks can be produced with the same simple tools.

It is preferred to provide blank holders adjacent to the knives, wherein these blank holders prevent the material to be cut form warping in areas located adjacent to the cut and thereby significantly reduce the formation of burrs.

In an alternative embodiment, the device comprises counter-blades instead of cutting bars in order to cut the material sheets in a shear cutting process. In this way, the cutting forces can be reduced in comparison with the knife cut.

### BRIEF DESCRIPTION OF THE DRAWING

An exemplary embodiment of the inventive device is described in greater detail below with reference to the figures. In these figures:

FIG. 1 shows a schematic illustration of the arrangement of a material sheet and the tools; and

FIG. 2 shows a perspective illustration of an individual cutting unit.

### DETAILED DESCRIPTION

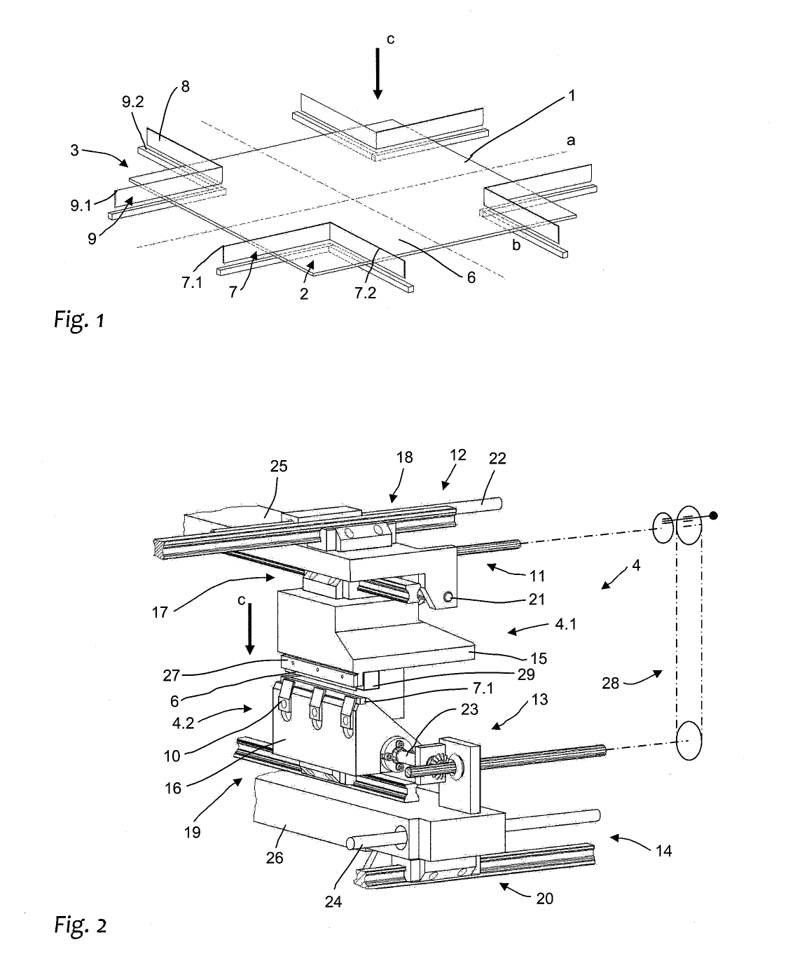

With reference to the FIGS. 1 and 2, the cutting cell of the preferred device comprises four identical cutting units 4 that respectively feature a knife 6, 8 with rectangular contour and a cutting bar 7, 9, wherein the cutting bar is respectively composed of segments 7.1 and 7.2., 9.1 and 9.2 that are arranged perpendicular to one another and have a square cross section. FIG. 1 shows the arrangement of the tools, in which their angles respectively point into the material sheet 1 and one limb of two opposing knives 6, 8 is respectively oriented coaxially. The limbs of the knives 6, 8 and of the counter-blades 7, 19 protrude over the material sheet 1 in this case such that each cutting unit 4 respectively separates a rectangular area 2, 3 and a cruciform blank is obtained. Such a tool configuration is suitable, e.g., for separating the corner areas of cross-grooved cardboards or box covers that can be further processed into dimensionally stable boxes.

In the present context, “contour” refers to a peripheral shape. As shown in FIG. 1 the device has knives at the corners of the sheet 1 for cutting away distinct, discontiguous sections of the sheet, resulting in a sectionally concave contour.

FIG. 2 shows an example of one of four identical cutting units that can be separated into an upper unit 4.1 carrying the knife 6 and a lower unit 4.2 carrying the cutting bar 7. The lower unit 4.2 is connected to the not-shown frame of the device by means of two linear guides 19, 20 that are arranged perpendicular to one another and the support 26 positioned between the linear guides such that it can be displaced in the direction of a first straight line a, as well as in the direction of a second straight line b. It comprises a receptacle base 16, in which the segments 7.1 and 7.2 of the cutting bar 7 are angularly mounted (e.g., perpendicularly) relative to one another with the aid of clamping means 10. This receptacle 16 is designed in an outwardly descending fashion in order to transport the separated section 2 downward to a device for collecting or removing the sections 2, 3 past the linear guides 19, 20. The numeric ID's 7, 9 also represent a counter-blade alternative to the illustrated square counter-bar.

The upper unit 4.1 comprises a knife receptacle 15, in which the knife 6 is mounted with the aid of clamps 27. It is arranged on the not-shown press plate of the device at angles similar to the angles on the cutting bars. The press plate is driven in the vertical direction c, by means of two linear guides 17, 18 that are arranged perpendicular to one another and connected by means of a support 25. One of the linear guides 17, 18 of the upper unit 4.1 is respectively arranged parallel to one of the linear guides 19, 20 of the lower unit 4.2 such that both units can be moved parallel to the same straight lines a and b.

A first adjusting device 11 assigned to the upper unit 4.1 causes a displacement of this unit along the first linear guide 17 by means of a spindle 21 whereas a second adjusting device 12 causes a displacement of the unit along the second linear guide 18. A third adjusting device 13, which acts in the direction of the third linear guide 19 via a spindle 23, and a fourth adjusting device 14, which acts in the direction of the fourth linear guides 20 via an additional spindle 24, are assigned to the lower unit 4.2.

The respective adjusting devices 11 and 13, 12 and 14 that act in the same direction are motively connected to one another, wherein these connections respectively comprise a conventional separable coupling such that an adjustment of the lower unit 4.2 relative to the upper unit 4.1, as well as an overall adjustment of the cutting unit 4, can be achieved. FIG. 2 shows a motive connection 28 with a handle for connecting or disconnecting the respective adjusting devices. This figure also shows elastic blank holders 29 arranged adjacent to the knives 6, 8.

In this case, the actuation of all adjusting devices 11, 12, 13 and 14 may be realized manually with the aid of conventional actuating means such as, e.g., a hand wheel or with motor drives that communicate with a likewise control of the device.

The device comprises four identical cutting units 4 of the described type that are arranged in accordance with FIG. 1, wherein the adjusting devices 11, 12, 13, 14 of the cutting units, which respectively act along the same straight lines a, b, are motively connected such that a symmetric adjustment referred to the center axes is inevitably achieved.

1. A device for cutting plane material sheets (1) to a sectionally concave contour, comprising: at least two cutting units (4) that respectively feature at least one knife (6, 8) and one cutting bar (7, 9), between which knives and cutting bars plane sheet material is positioned to be cut as the knives (6, 8) carry out a linear cutting motion in a direction (c) extending perpendicularly to said plane toward the cutting bars (7, 9) during one work cycle; wherein the cutting units (4) are arranged such that at least two discontiguous sections (2, 3) are cut away from the same material sheet (1) during one work cycle; and wherein at least one of the cutting units (4) is connected to a first adjusting device (11) for arranging the cutting units (4) relative to one another along at least a first straight line (a) extending parallel to the material sheet (1) when positioned for the cutting.

2. The device according to claim 1, wherein at least one of the cutting units (4) is connected to a second adjusting device (12) for positioning said at least one of the cutting units (4) superimposed along a second straight line (b) that is oriented perpendicular to the first straight line (a) and that together with the first straight line define a plane extending parallel to the material sheet (1).

3. The device according to claim 2, wherein at least one of the cutting bars (7, 9) is connected to a third adjusting device (13) for positioning relative to the at least one knife (6, 8) of the same cutting unit (4).

4. The device according to claim 3, including a separable motive connection between the third adjusting device (13) and one of the first or the second adjusting device (11, 12).

5. The device according to claim 3, wherein the at least one cutting bar (7, 9) is adjustably connected to one of the first or the second adjusting device by the third adjusting device (13).

6. The device according to claim 1, including clamps (10) for mounting the cutting bars (7, 9) on a base (16).

7. The device according to claim 1, wherein each cutting bar (7, 9) includes angled segments (7.1, 7.2, 9.1, 9.2) and each segment has a square cross section.

8. The device according to claim 1, wherein each cutting bar (7, 9) includes angled segments (7.1, 7.2, 9.1, 9.2) and each segment consists essentially of a material that is more yielding than the material of the knives (6, 8).

9. The device according claim 1, wherein each knife defines an open, angled contour.

10. The device according claim 1, including blank holders arranged adjacent to the knives (6, 8).

11. The device according to claim 1, wherein the cutting bars (7, 9) are in the form of counter-blades.

12. The device according to claim 9, wherein at least one of the cutting units (4) is connected to a second adjusting device (12) for positioning said at least one of the cutting units (4) along a second straight line (b) that is oriented perpendicular to the first straight line (a) and that together with the first straight line define a plane extending parallel to the material sheet (1).

13. The device according to claim 9, wherein at least one of the cutting bars (7, 9) is connected to an adjusting device (13) for positioning relative to the at least one knife (6, 8) of the same cutting unit (4).

14. A cutting cell for cutting plane material sheets (1) to a sectionally concave contour, comprising:
four identical cutting units (4) that respectively feature one angled knife (6, 8) and one angled counter bar (7, 9), between which knives and counter bars plane sheet material is positioned to be cut as the knives (6, 8) carry out a linear cutting motion in a direction (c) extending perpendicularly to said plane toward the counter bars (7, 9) during one work cycle; wherein
the cutting units (4) are arranged as a rectangular with apices of the knives and counter bars pointing toward the center of the rectangle such that four discontiguous sections (2, 3) are cut away from the same material sheet (1) simultaneously, leaving a cruciform shape of the cut sheet;
a plurality of cutting units (4) is connected to a first adjusting device (11) for arranging the cutting units (4) relative to one another along a first straight line (a) extending parallel to the material sheet (1) when positioned for the cutting;
said plurality of cutting units (4) is connected to a second adjusting device (12) for positioning the cutting units (4) along a second straight line (b) that is oriented perpendicular to the first straight line (a); and
each counter bar (7, 9) is connected to a third adjusting device (13) for positioning relative to the at least one knife (6, 8) of the same cutting unit (4).

15. The device according to claim 14, including a separable motive connection between the third adjusting device (13) and one of the first or the second adjusting device (11, 12).

16. The device according to claim 14, wherein the at least one counter bar (7, 9) is adjustably connected to one of the first or the second adjusting device by the third adjusting device (13).

17. The device according to claim 14, wherein each counter bar (7, 9) includes angled segments (7.1, 7.2, 9.1, 9.2) and each segment has a square cross section.

18. The device according to claim 14, wherein the counter bars (7, 9) are counter-blades.
